(19) United States
(12) Patent Application Publication
(10) Pub. No.: US 2026/0037489 A1
(43) Pub. Date: Feb. 5, 2026

(54) COMPRESSION OF DATA INCLUDING EMBEDDED METADATA

(71) Applicant: MaxLinear, Inc., Carlsbad, CA (US)

(72) Inventors: Pinaki Shankar Chanda, San Diego, CA (US); Michael Ray Ham, San Jose, CA (US)

(73) Assignee: MaxLinear, Inc., Carlsbad, CA (US)

(21) Appl. No.: 19/291,552

(22) Filed: Aug. 5, 2025

Related U.S. Application Data
(60) Provisional application No. 63/679,600, filed on Aug. 5, 2024.

(51) Int. Cl. G06F 16/215

(52) U.S. Cl. CPC G06F 16/215

(57) ABSTRACT

A method may include obtaining input data to be compressed by a compression operation. The method may also include obtaining metadata associated with the input data to be compressed by the compression operation. The method may further include determining a data threshold of the input data and the metadata to be compressed by the compression operation. The method may also include preprocessing the metadata. The method may further include arranging the input data and the metadata based on the data threshold. The method may also include performing the compression operation on the arranged input data and the arranged metadata.

### CROSS REFERENCE TO RELATED APPLICATIONS

This U.S. Patent application claims priority to U.S. Provisional Patent Application No. 63/679,600, titled “COMPRESSION OF DATA INCLUDING EMBEDDED METADATA,” and filed on Aug. 5, 2024, the disclosure of which is hereby incorporated by reference in its entirety.

### TECHNICAL FIELD

This disclosure generally relates to data compression, and more specifically, to data compression to input data that includes embedded metadata.

### BACKGROUND

Unless otherwise indicated herein, the materials described herein are not prior art to the claims in the present application and are not admitted to be prior art by inclusion in this section.

Data compression operations may be performed by software and/or various hardware devices, such as a computational storage device, a network interface card, a graphical processing unit, and/or other devices. In some instances, input data to be compressed may include metadata, including different fields of metadata, where the metadata data may be dispersed throughout the input data. The inclusion of the metadata throughout the input data during compression may result in a decreased efficiency of the data compression operation.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a method may include obtaining input data to be compressed by a compression operation. The method may also include obtaining metadata associated with the input data to be compressed by the compression operation. The method may further include determining a data threshold of the input data and the metadata to be compressed by the compression operation. The method may also include preprocessing the metadata. The method may further include arranging the input data and the metadata based on the data threshold. The method may also include performing the compression operation on the arranged input data and the arranged metadata.

In another embodiment, a system may include a host device and a compression device. The host device may be configured to obtain input data to be compressed by a compression operation. The host device may also be configured to obtain metadata associated with the input data, to be compressed by the compression operation. The host device may further be configured to determine a data threshold of the input data and the metadata to be compressed by the compression operation. The host device may also be configured to preprocess the metadata. The host device may further be configured to arrange the input data and the metadata based on the data threshold. The host device may also be configured to transmit the arranged input data and the arranged metadata to the compression device. The compression device may be configured to perform the compression operation on the arranged input data and the arranged metadata.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for compression of data including metadata;

FIG. 2 illustrates a flow of data and metadata in a compression operation;

FIG. 3 illustrates a diagram of input data and metadata being arranged in preparation for a compression operation;

FIG. 4 illustrates a diagram of metadata being sorted in preparation for a compression operation;

FIG. 5 illustrates a flow of data and metadata in a decompression operation;

FIG. 6 illustrates a flowchart of an example method of compression of data including metadata; and

FIG. 7 illustrates an example computing device.

### DETAILED DESCRIPTION

In some instances, input data to be compressed via a compression operation may include metadata embedded therein, where the input data may be subdivided into multiple sectors. For example, the input data may include T10-data integrity field (DIF) non-volatile memory express (NVMe) protection information (PI) and/or T10-data integrity extension (DIX) NVMe PI metadata, where one T10-DIF entry or one T10-DIX entry may be included in each sector of the input data. Alternatively, or additionally, the input data to be compressed may include metadata associated therewith, although the metadata may not be embedded within the input data.

In some instances, the input data and/or the metadata may be verified in view of one or more fields of the metadata. For example, in instances in which the metadata is T10-DIF and/or T10-DIX, the verification process may verify one or more of the application (APP) field and/or the reference (REF) field against expected values, and the verification process may verify the cyclic redundancy check (CRC) field by computing CRC of the input data in the particular sector and the result may be compared to the CRC field provided in the metadata.

The metadata may be dispersed in the input data and/or the metadata may be associated with the input data without being embedded therein. In instances in which the metadata is embedded in the input data, the metadata may be dispersed at a fixed interval in the input data (e.g., as in T10-DIF) and/or the metadata may be dispersed in arbitrary location in the input data. In instances in which the metadata is dispersed arbitrarily, the compression device (e.g., a data transform accelerator) may be informed of the arbitrary location of the metadata, either directly or indirectly. Alternatively, or additionally, the metadata may be associated with the input data and disposed in a buffer separate from the input data prior to the compression operation.

In instances in which the metadata is embedded in the input data and after verification (if applicable), the input data with embedded metadata may be transmitted for the compression operation. In instances in which the metadata is disposed in a buffer separate from the input data, and/or after optional verification, the metadata may be embedded into the input data at a predefined location within the input data and the input data with embedded metadata may be sent for the compression operation.

As described, the compression operation may be performed by a compression device, where the compression device may be a software device and/or a hardware device. In instances in which the compression device is a hardware device, the hardware device may be one or more of a data transform accelerator, a computational storage device, a storage appliance server, a network interface card, a general-purpose computer system, a graphics processing unit (GPU), an application specific integrated circuit (ASIC), and/or a field programmable gate array (FPGA).

For a decompression operation, a decompression algorithm may be operable to decompress the compressed input data with embedded metadata. Upon completion of the decompression operation, the embedded metadata within the input data may be verified (e.g., not limited to check the integrity of the input data). After verification of the embedded metadata, the embedded metadata may remain embedded in the input data (e.g., as in T10-DIF), the metadata may be removed and transmitted separately from the input data (e.g., as in T10-DIX), and/or the metadata may be removed from the input data and/or discarded.

In instances in which the input data includes embedded metadata, the embedded metadata may break the pattern in the input data, which may result in a compression operation on the input data being less efficient (e.g., resulting in a reduction in compression ratio of the input data). Alternatively, or additionally, the embedded metadata in the input data may have commonality with other embedded metadata and as the embedded metadata may be scattered in the input data, the compression algorithms may not able to exploit the metadata commonality effectively to improve the compression operations.

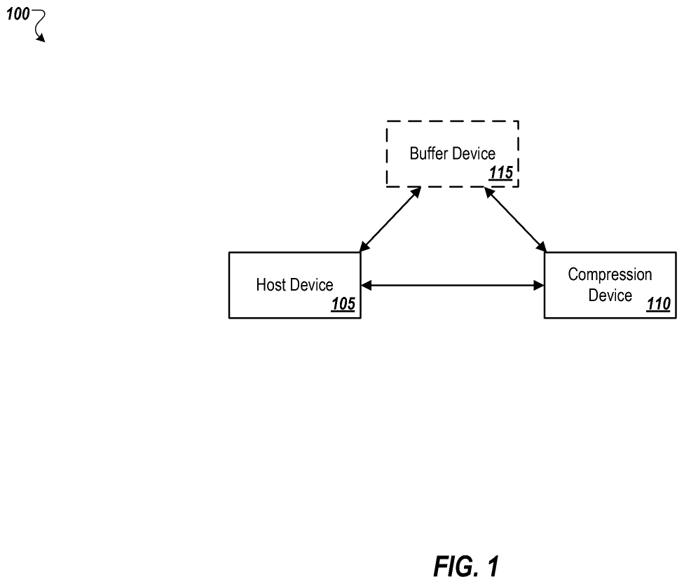

FIG. 1 illustrates a block diagram of an example system 100 for compression of data including metadata. The system 100 may include a host device 105, a compression device 110, and a buffer device 115.

The host device 105 may be a computer, server, and/or other computing device that may be in communication with the compression device 110 and/or the buffer device 115. In some instances, the host device 105 may utilize a data communication interface (e.g., a Peripheral Component Interconnect express (PCIe) interface, a Universal Serial Bus (USB) interface, and/or other similar data communication interfaces) to communicate with the compression device 110 and/or with the buffer device 115.

The host device 105 may be operable to obtain the input data and/or the associated metadata. For example, the host device 105 may obtain the input data and metadata may be embedded therein. In another example, the host device 105 may obtain the input data and the host device 105 may be operable to determine metadata that may be associated with the input data and the host device 105 may obtain the associated metadata, such as from the buffer device 115.

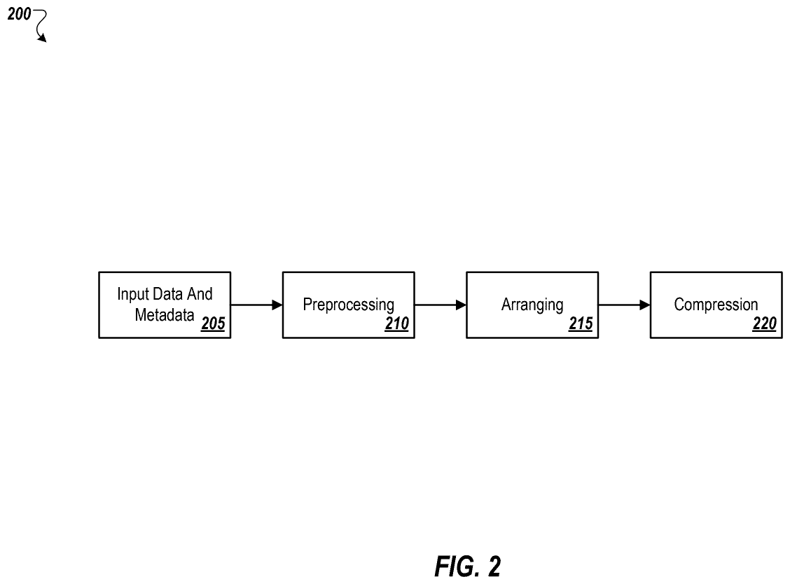

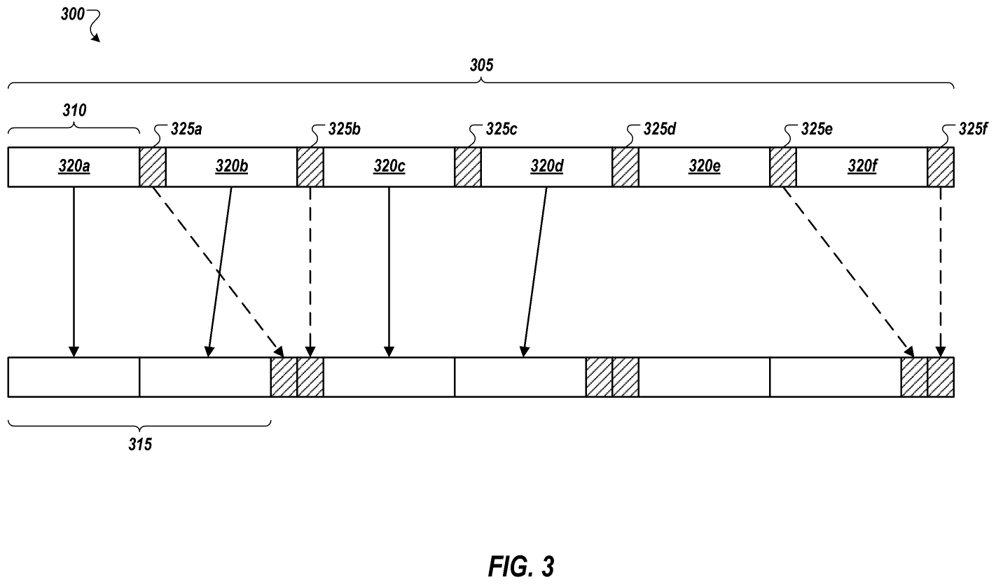

In some instances, the input data may be separated by sectors, where a sector may refer to a portion of the input data that may include an associated portion of metadata. The input data may be transmitted as a data stream and/or a data frame. In some instances, the metadata may be disposed at the start of a sector, at the end of a sector, and/or in any other portion of the sector (which may be a predetermined location within the sector). In some instances, the metadata may include one or more fields, where the metadata may be further separated and/or arranged prior to the compression operation, as described herein. In some instances, a data frame may be transmitted from the host device 105 to the compression device 110, as described herein, such as relative to FIG. 2 and/or FIG. 3.

In some instances, the host device 105 may be operable to obtain the input data and the metadata. In some instances, the metadata may be embedded in the input data. Alternatively, or additionally, in some instances, the host device 105 may obtain the input data and the metadata separately from one another. In some instances, the input data may be verified using the metadata. For example, as input data becomes available (e.g., in a sector by sector basis) and the associated metadata becomes available (e.g., either as embedded in the input data or obtained from the buffer device 115), the input data may be verified using the metadata. For example, in instances in which the metadata is T10-DIF or T10-DIX, the APP field and/or the REF field of the metadata may be verified against expected values for the APP field and/or the REF field, respectively, and/or the CRC field of the metadata may be compared against the CRC computed on the associated sector of the input data.

In some instances, the host device 105 may be operable to determine a data threshold associated with the compression device 110. The data threshold may be an amount of the input data and/or the metadata to be compressed in a compression operation by the compression device 110. The data threshold may include any number of sectors of the input data. For example, in some instances, the compression device 110 may be operable to compress data that may include two sectors of input data and associated metadata at a time.

In some instances, the data threshold may be a predefined amount of data, such as based on capabilities associated with the compression device 110. For example, the data threshold may be based on an amount of buffering encode pipeline and/or decode pipeline in the compression device 110. In another example, the data threshold may be based on a resource availability and/or an amount of latency permitted in the decode operation in the compression device 110. In some instances, the data threshold may be programmed to the compression device 110 using the interface between the host device 105 and the compression device 110.

In these and other instances, the input data and/or the metadata may be transmitted from the host device 105 to the compression device 110 for compression operations. In some instances, processing of the metadata may be performed in parallel with the input data that may be sent to the compression device 110 for the compression operations.

The compression device 110 may be a hardware device that may be operable to perform at least a compression operation. For example, the compression device 110 may be operable to obtain data (e.g., input data and/or associated metadata) from the host device 105 and the compression device 110 may be operable to perform a compression operation to the data, which may compress the size of the data. In some instances, the compression device 110 may be operable to perform other operations, such as decompression operations, transformations, and the like. In some instances, the compression device 110 may be a data transform accelerator, a computational storage device, a storage appliance server, a network interface card, a general-purpose computer system, a graphics processing unit (GPU), an application specific integrated circuit (ASIC), and/or a field programmable gate array (FPGA). Alternatively, or additionally, the compression device 110 may be software that may be configured to perform the same or similar operations as described relative to the hardware device implementation of the compression device 110.

The buffer device 115 may be operable to store data, such as from the host device 105 and/or from the compression device 110. In some instances, the buffer device 115 may be operable to store metadata associated with the input data until the metadata may be combined with the input data prior to compression by the compression device 110. Alternatively, or additionally, the buffer device 115 may be operable to store decompressed data, that may include decompressed input data and/or decompressed metadata, prior to the decompressed data being output from the compression device 110 (e.g., where the compression device 110 may be operable to perform decompression operations in addition to or in the alternative to compression operations).

In an example, input data may be received by the host device 105 that may include metadata associated therewith (e.g., the metadata may be embedded in the input data or the metadata may be disposed in the buffer device 115). The host device 105 may be operable to group sectors of the input data in view of a data threshold that may be associated with the compression device 110. In conjunction with grouping the sectors, the host device 105 may be operable to group the metadata associated with the grouped sectors and dispose the grouped metadata adjacent to the grouped sectors. In some instances, grouping the metadata may include identifying one or more fields associated with the metadata and grouping the fields that may be similar to one another together. After the sectors and the metadata have been arranged as described, the host device 105 may transmit the sectors and metadata to the compression device 110 for a compression operation. In some instances, the rearranging and/or grouping of sectors and/or metadata (and/or fields of the metadata) may . . . improve the compression operation by the compression device 110 by grouping data (e.g., the sectors and/or the metadata) near each other which may share commonalities. As such, the compression ratio may improve when compared to compression operations on input data that may have metadata disposed throughout.

Modifications, additions, or omissions may be made to the system 100 without departing from the scope of the present disclosure. For example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

FIG. 2 illustrates a flow 200 of data and metadata in a compression operation. The flow 200 may include an obtaining input data and metadata step 205, a preprocessing step 210, an arranging step 215, and a compression step 220.

At the obtaining input data and metadata step 205, input data and/or metadata associated with the input data may be obtained. The input data and/or the metadata may be obtained for a compression operation and the input data may be a data frame that may include multiple sectors. In some instances, the metadata may be embedded in the input data. Alternatively, or additionally, the metadata may be disposed in a buffer separate from the input data, and once obtained, the metadata may be combined with the input data. The metadata may be disposed at the beginning of a sector, the end of a sector, and/or or in some other predefined location in a sector.

At the preprocessing step 210, the input data and/or the metadata may be verified in view of one or more fields of the metadata. For example, in instances in which the metadata is T10-DIF and/or T10-DIX, the verification process may verify one or more of the APP field and/or the REF field against expected values, and the verification process may verify the CRC field by computing CRC of the input data in the particular sector and the result may be compared to the CRC field provided in the metadata.

In some instances, after the input data and/or the metadata is verified, the metadata may be buffered in a buffer and the input data may be transmitted for the compression operations. metadata after the sectors

Alternatively, or additionally, in some instances, after the input data and/or the metadata is verified, the input data and the metadata may be buffered together prior to being transmitted for the compression operations. In some instances, the input data and/or the metadata may be buffered until the number of sectors of the input data satisfy the data threshold associated with the compression device, as described herein. In these and other instances, the verification of the input data and/or the metadata may be an optional step in the flow 200.

At the arranging step 215, the metadata may be processed for the compression operations, and/or the input data may arranged prior to the compression operations (e.g., a number of sectors of the input data may be grouped to satisfy the data threshold). In some instances, the data threshold may include any number of sectors of the input data. In some instances, the data threshold may be a predefined amount of sectors, such as based on capabilities associated with the compression device. For example, the data threshold may be based on an amount of buffering encode pipeline and/or decode pipeline in the compression device. In another example, the data threshold may be based on a resource availability and/or an amount of latency permitted in the decode operation in the compression device. In some instances, the data threshold may be programmed to the compression device using an interface between a host device and the compression device, such as described relative to the system 100 of FIG. 1.

In some instances, processing the metadata may be done in parallel as the input data may be transmitted for the compression operations. In some instances, processing the metadata may include rearranging the metadata based on one or more fields of the metadata and/or based on the sectors that may be grouped in view of the data threshold. For example, in instances in which the metadata includes a first field, a second field, and a third field, the first field of a first metadata may be arranged to be adjacent to the first field of a second metadata, the second field of the first metadata may be arranged to be adjacent to the second field of the second metadata, and the third field of the first metadata may be arranged to be adjacent to the third field of the second metadata. In the example, two metadata (each having three fields) are provided. It will be appreciated that any number of metadata may be included in the rearranging, and/or the number of metadata include may be based on the number of sectors to be grouped in view of the data threshold, as described herein. Alternatively, or additionally, any number of fields in the metadata may be supported, as any number of similar fields may be arranged with each other as described.

At the compression step 220, the input data and the metadata may be transmitted to a compression device for a compression operation to be performed. In instances in which the input data is transmitted for the compression operation while the metadata is buffered then transmitted, the metadata corresponding to the grouped input data (e.g., grouped in view of the data threshold) may be disposed after the grouped input data for transmitting to the compression device and/or after the compression operation. In instances in which the input data is buffered along with the metadata (and while the metadata is rearranged, as described) and the metadata is transmitted for the compression operation before the input data, the metadata corresponding to the grouped input data (e.g., grouped in view of the data threshold) may be disposed before the grouped input data for transmitting to the compression device and/or after the compression operation.

In these and other instances, the compression device may be operable to perform a compression operation on the input data and the metadata. In some instances, arranging the input data in sectors in view of the data threshold and grouping (and/or sorting) the metadata may improve the compression operations as the input data and/or the metadata may include commonalities with each other, respectively, and better compression ratios may be achieved due to the commonalities of the grouped input data and/or the grouped metadata.

Modifications, additions, or omissions may be made to the flow 200 without departing from the scope of the present disclosure. For example, the designations of different elements in the manner described is meant to help explain concepts described herein and is not limiting. Further, the flow 200 may include any number of other elements or may be implemented within other systems or contexts than those described. For example, any of the components of FIG. 2 may be divided into additional or combined into fewer components.

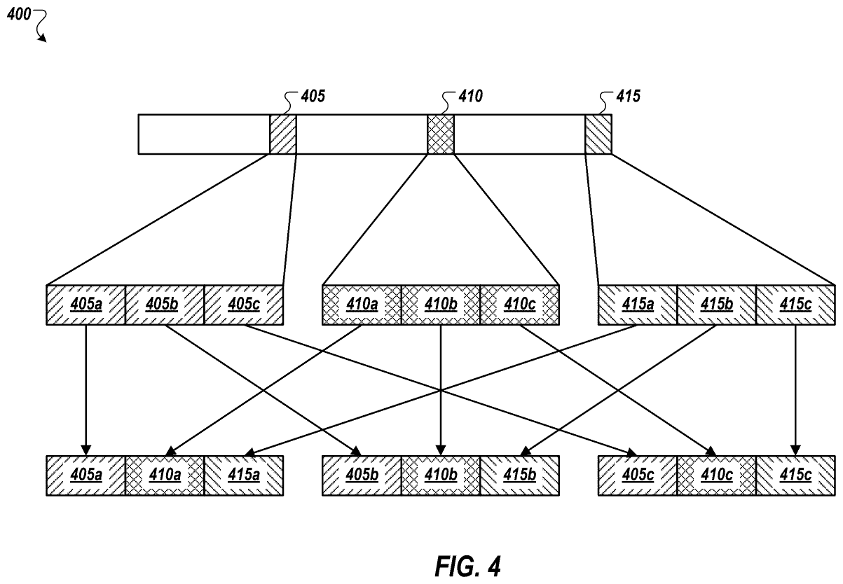

FIG. 3 illustrates a diagram 300 of input data and metadata being arranged in preparation for a compression operation and FIG. 4 illustrates a diagram 400 of metadata being sorted in preparation for a compression operation. The diagram 300 may include a frame size 305, a sector size 310, a data threshold 315, a first sector 320a, a second sector 320b, a third sector 320c, a fourth sector 320d, a fifth sector 320e, a sixth sector 320f, referred to collectively as the sectors 320, a first metadata 325a, a second metadata 325b, a third metadata 325c, a fourth metadata 325d, a fifth metadata 325e, and a sixth metadata 325f, referred to collectively as the metadata 325.

The diagram 300 illustrates the metadata 325 being accumulated and/or preprocessed before being sent for compression operations, as described herein. As illustrated, the frame size 305 may include six sectors (e.g., the sectors 320) and the data threshold 315 may include two of the sectors 320. For example, the first sector 320a and the second sector 320b may be grouped to satisfy the data threshold 315, the third sector 320c and the fourth sector 320d may be grouped to satisfy the data threshold 315, and so forth.

In some instances, the metadata 325 associated with the grouped sectors 320 may be arranged together prior to compression. For example, in instances in which the first sector 320a and the second sector 320b are grouped, the first metadata 325a and the second metadata 325b may be grouped and/or may be disposed adjacent to the grouped sectors 320. In some instances, the grouped metadata 325 may be disposed after the grouped sectors 320 (e.g., as illustrated in FIG. 3). Alternatively, or additionally, the grouped metadata 325 may be disposed before the grouped sectors 320.

Depending on the size of the data threshold 315 and/or the sector size 310, any number of the sectors 320 may be grouped together, and subsequently, any number of the metadata 325 may be grouped together. For example, in instances in which the data threshold 315 is larger than illustrated such that four of the sectors 320 may satisfy the data threshold 315, then the first sector 320a, the second sector 320b, the third sector 320c, and the fourth sector 320d may be grouped, and subsequently, the first metadata 325a, the second metadata 325b, the third metadata 325c, and the fourth metadata 325d may be grouped and disposed adjacent to the grouped sectors 320 as described.

The diagram 400 may include first metadata 405, second metadata 410, and third metadata 415. The first metadata 405 may include a first field 405a, a second field 405b, and a third field 405c. The second metadata 410 may include a first field 410a, a second field 410b, and a third field 410c. The third metadata 415 may include a first field 415a, a second field 415b, and a third field 415c. In some instances, the first metadata 405, the second metadata 410, and/or the third metadata 415 may be the same or similar as the metadata 325 of FIG. 3.

As illustrated in the diagram 400, arranging the metadata (e.g., the first metadata 405, the second metadata 410, and the third metadata 415) may include identifying fields in the metadata and reorganizing the fields by grouping similar fields together. For example, as illustrated, the first metadata 405, the second metadata 410, and the third metadata 415 may be grouped together based on the associated sectors being grouped in view of a data threshold, as described herein, and in conjunction with grouping the metadata, the fields within the metadata may be identified and grouped. For example, the first field 405a of the first metadata 405, the first field 410a of the second metadata 410, and the first field 415a of the third metadata 415 may be grouped together. Continuing the example, the second field 405b of the first metadata 405, the second field 410b of the second metadata 410, and the third field 415c of the third metadata 415 may be grouped together. The grouping may be used for any number of metadata and/or for any number of fields that may be included in the metadata.

In an example, T10-DIF metadata may include three fields: an APP field, a REF field, and a CRC field. In instances in which a sector size is 512 bytes, and 32768 bytes of data are sent for compression operations, there may be 64 sectors, such that 64 T10-DIF metadata may be accumulated in the metadata buffer. The APP fields from 64 T10-DIFs may be reorganized sequentially, then the 64 REF fields may be reorganized and grouped, and the 64 CRC may be reorganized and grouped. Such an arrangement is illustrated in FIG. 4, where three T10-DIF fields may be illustrated. Note that for other types of metadata, which may be application specific, other types of reorganization may be applicable and/or no reorganization may be employed.

As illustrated in FIG. 4, the metadata (e.g., the example included T10-DIF metadata) may be reorganized and/or grouped together before being transmitted for compression operations. Alternatively, or additionally, different organizations of the metadata may be used. For example, the metadata may be grouped together without reorganizing the metadata fields. Alternatively, or additionally, the fields can be organized in a different order, which may be determined based on a similarity or ease of compression, such as by a dictionary-based compression algorithm.

In some instances, the processing of the metadata can happen as the input data is being transmitted for the compression operations, such that the metadata processing may overlap some or all of the transmission of the input data for the compression operations. Alternatively, or additionally, the input data and the metadata may be buffered, followed by reorganizing and grouping the metadata, as described herein, and the input data may be sent for the compression operations, followed by the reorganized and grouped metadata.

In some instances, the input data may not have metadata embedded therein, and/or the input data may not have metadata available separately (e.g., the metadata may be empty). In such instances (e.g., data protection), metadata may be added to the input data by the hardware and/or by software. For example, in instances in which the compression device is a data transform accelerator and no metadata is included with the input data, the data transform accelerator may be operable to add metadata to the input data. In such instances, after a predefined amount of input data may be sent for the compression operations, the metadata fields (e.g., the APP field, the REF field, and/or the CRC field, as described) may be computed for each sector . . . with information from a user and/or the compute operations inside the hardware, and the metadata fields may be organized and sent for compression operations.

Modifications, additions, or omissions may be made to the diagram 300 and/or the diagram 400 without departing from the scope of the present disclosure. For example, the designations of different elements in the manner described is meant to help explain concepts described herein and is not limiting. Further, the diagram 300 and/or the diagram 400 may include any number of other elements or may be implemented within other systems or contexts than those described. For example, any of the components of FIG. 3 and/or FIG. 4 may be divided into additional or combined into fewer components.

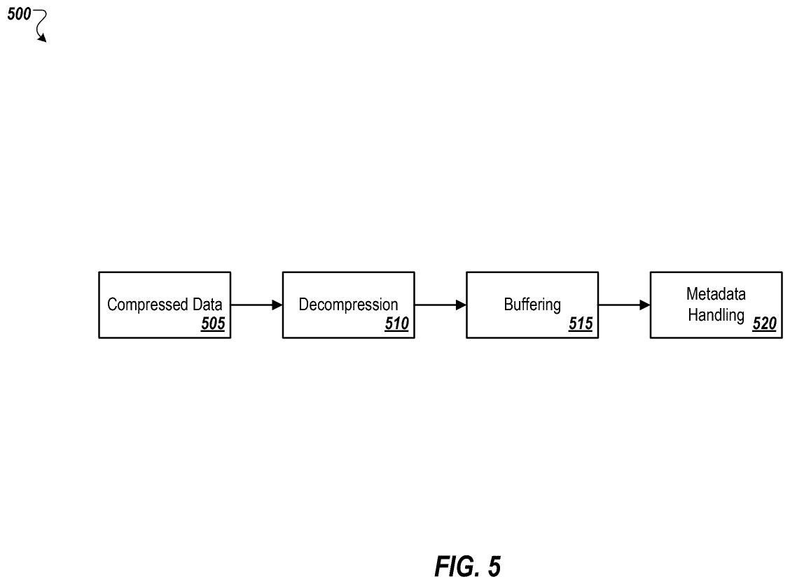

FIG. 5 illustrates a flow 500 of data and metadata in a decompression operation. The flow 500 may include a receiving compressed data step 505, a decompression step 510, a buffering step 515, and a metadata handling step 520.

At the receiving compressed data step 505, a compression device (and/or a decompression device, which may be the same device) may obtain compressed data, where the compressed data may be compressed in the manner described herein. In some instances, the compressed data may be obtained from a storage device, where the compressed data may have been stored until the decompression operation may be performed. In some instances, the metadata may be disposed at a beginning portion of the compressed data. Alternatively, or additionally, the metadata may be disposed at an end portion of the compressed data.

At the decompression step 510, a decompression operation may be performed on the compressed data to obtain the input data and the associated metadata. In some instances, the decompression operation may be performed in a decode direction of the compression device.

At the buffering step 515, the metadata and/or the input data (e.g., the decompressed metadata and/or the decompressed input data) may be stored in a buffer. Once the buffer contains the input data and the metadata, the metadata may be processed to reverse the compression operations performed by the compression device. The reverse process may include rearranging the fields of the metadata to bring the metadata back to a pre-compressed format and/or may include reinserting the metadata in the sector as the metadata was in the input data sent to the compression device.

In some instances, the metadata and/or the input data may be verified after the decompression operation. For example, in instances in which the metadata is T10-DIF, the APP field and/or the REF field may be compared against expected values for the APP field and/or the REF field, respectively. Alternatively, or additionally, the CRC field may be compared against a computed CRC of the associated sector.

In some instances, the verification of the metadata and/or the input data may occur after the metadata and the input data are buffered and/or after the metadata is rearranged as described. Alternatively, or additionally, the verification may occur after the metadata is buffered and rearranged without the input data being buffered with the metadata.

At the metadata handling step 520, a determination as to how the metadata may be handled may be performed. In some instances, the metadata may be embedded with the input data such that both the input data and the metadata may be transmitted in unison (e.g., T10-DIF metadata), such as transmitted to a user. Alternatively, or additionally, the metadata may be separated from the input data and the metadata may be transmitted separately from the input data (e.g., T10-DIX), such as to the user. Alternatively, or additionally, the metadata may be dropped and the input data may be transmitted without the metadata. In instances in which the metadata is embedded in the input data, the metadata may be disposed in the input data in a predefined location of the sector, which may be the same or similar as the location in which the metadata was disposed prior to the compression operation, as described herein.

Modifications, additions, or omissions may be made to the flow 500 without departing from the scope of the present disclosure. For example, the designations of different elements in the manner described is meant to help explain concepts described herein and is not limiting. Further, the flow 500 may include any number of other elements or may be implemented within other systems or contexts than those described. For example, any of the components of FIG. 5 may be divided into additional or combined into fewer components.

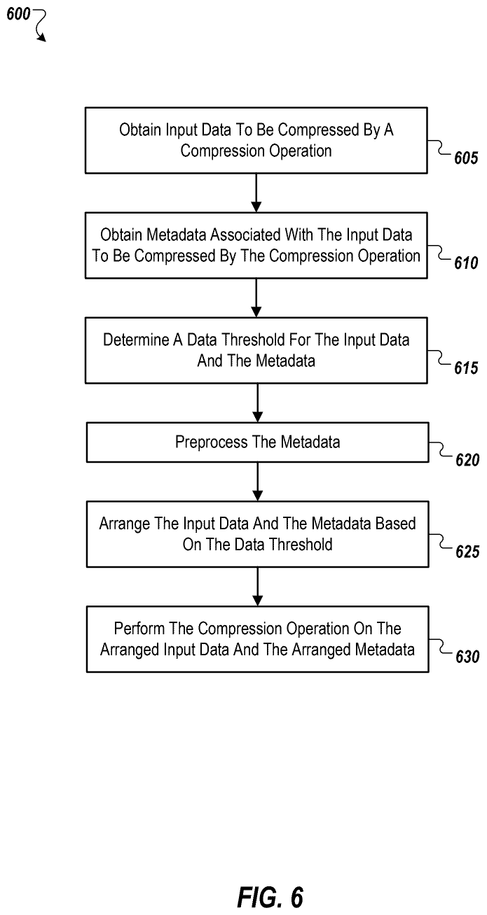

FIG. 6 illustrates a flowchart of an example method 600 of optimizing packet processing in a network, in accordance with at least one embodiment of the present disclosure. The method 600 may be performed by processing logic that may include hardware (circuitry, dedicated logic, etc.), software (such as is run on a general purpose computer system or a dedicated machine), or a combination of both, which processing logic may be included in any computer system or device such as the host device 105 and/or the compression device 110 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method may begin at block 605 where input data to be compressed by a compression operation may be obtained.

At block 610, metadata to be compressed by the compression operation may be obtained. The metadata may be associated with the input data. In some instances, the metadata may be embedded in the input data. Alternatively, or additionally, the metadata may be disposed in a buffer that may be separate from the input data.

At block 615, a data threshold may be determined using the input data and the metadata. In some instances, the data threshold may be based on a predetermined number of sectors of the input data to be included in the compression operation. In some instances, the predetermined number of sectors may be based on one or more of a compression device configured to perform the compression operation, a size of a pipeline in the compression device, resource availability in the compression device, and/or latency restrictions in the compression device.

In instances in which a grouping of a first sector of the input data and a second sector of the input data satisfy the data threshold, the first sector and the second sector may be arranged for the compression operation. Alternatively, or additionally, first metadata associated with the first sector and second metadata associated with the second sector may be arranged for the compression operation. In instances in which a grouping of the first sector, the second sector, and a third sector of the input data not satisfying the data threshold, the first sector and the second sector may be arranged for the compression operation and the third sector may not be arranged for the compression operation. Alternatively, or additionally, the first metadata and the second metadata may be arranged for the compression operation and third metadata associated with the third sector may not be arranged for the compression operation.

At block 620, the metadata may be preprocessed. In some instances, the preprocessing may include identifying at least a first field and/or a second field associated with the metadata. Alternatively, or additionally, the preprocessing may include grouping the first field of a first metadata with the first field of a second metadata prior to the compression operation. Alternatively, or additionally, the preprocessing may include grouping the second field of the first metadata with the second field of the second metadata prior to the compression operation.

At block 625, the input data may be arranged based on the data threshold. Alternatively, or additionally, the metadata may be arranged based on the arranged input data. In some instances, the arranging may include grouping the input data in an amount to satisfy the data threshold. Alternatively, or additionally, the arranging may include grouping the metadata associated with the grouped input data and/or disposing the grouped metadata adjacent to the grouped input data.

At block 630, the compression operation may be performed on the arranged input data and the arranged metadata. In some instances, the compression operation may be performed by a data transform accelerator.

Modifications, additions, or omissions may be made to the method 600 without departing from the scope of the present disclosure. For example, in response to the metadata being empty, metadata may be added to the input data. In such instances, the added metadata may be determined based on user input and/or compute operations performed by the compression device. In another example, the metadata may be verified by comparing the metadata to an expected value. Alternatively, or additionally, the input data may be verified using the metadata.

In another example, the designations of different elements in the manner described is meant to help explain concepts described herein and is not limiting. Further, the method 600 may include any number of other elements or may be implemented within other systems or contexts than those described.

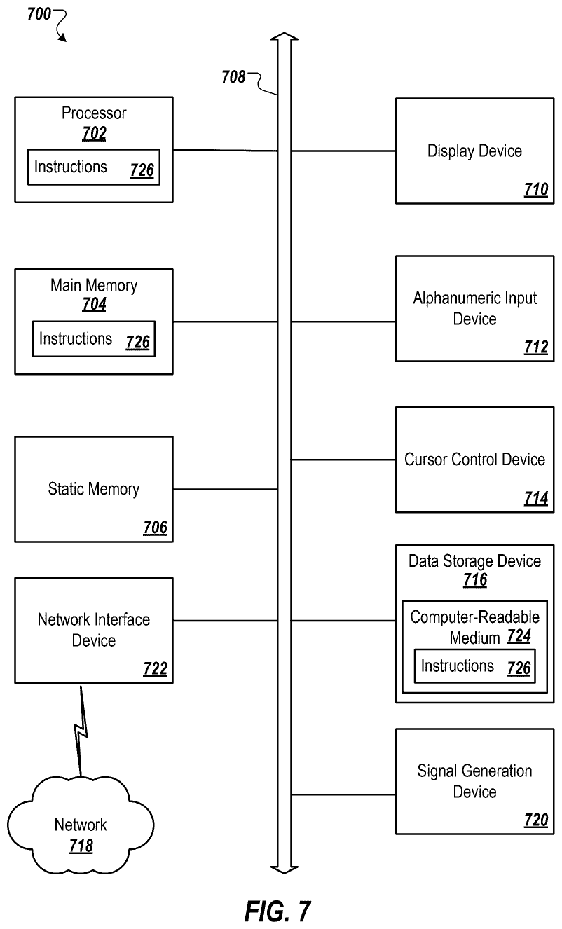

FIG. 7 illustrates an example computing device 700 within which a set of instructions, for causing the machine to perform any one or more of the methods discussed herein, may be executed. The computing device 700 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 700 includes a processing device 702 (e.g., a processor), a main memory 704 (e.g., read-only memory (ROM), flash memory, dynamic random access memory (DRAM) such as synchronous DRAM (SDRAM)), a static memory 706 (e.g., flash memory, static random access memory (SRAM)) and a data storage device 716, which communicate with each other via a bus 708.

The processing device 702 represents one or more general-purpose processing devices such as a microprocessor, central processing unit, or the like. More particularly, the processing device 702 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also include one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein.

The computing device 700 may further include a network interface device 722 which may communicate with a network 718. The computing device 700 also may include a display device 710 (e.g., a liquid crystal display (LCD) or a cathode ray tube (CRT)), an alphanumeric input device 712 (e.g., a keyboard), a cursor control device 714 (e.g., a mouse) and a signal generation device 720 (e.g., a speaker). In at least one implementation, the display device 710, the alphanumeric input device 712, and the cursor control device 714 may be combined into a single component or device (e.g., an LCD touch screen).

The data storage device 716 may include a computer-readable storage medium 724 on which is stored one or more sets of instructions 726 embodying any one or more of the methods or functions described herein. The instructions 726 may also reside, completely or at least partially, within the main memory 704 and/or within the processing device 702 during execution thereof by the computing device 700, the main memory 704 and the processing device 702 also constituting computer-readable media. The instructions may further be transmitted or received over the network 718 via the network interface device 722.

While the computer-readable storage medium 724 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A method, comprising:
obtaining input data to be compressed by a compression operation;
obtaining metadata associated with the input data, to be compressed by the compression operation;
determining a data threshold using the input data and the metadata;
preprocessing the metadata;
arranging the input data based on the data threshold and arranging the metadata based on the arranged input data; and
performing the compression operation on the arranged input data and the arranged metadata.

2. The method of claim 1, further comprising in response to the metadata being empty, adding metadata to the input data.

3. The method of claim 2, wherein the added metadata is determined based on user input and compute operations performed by a compression device performing the compression operation.

4. The method of claim 1, further comprising:
verifying the metadata by comparing the metadata to an expected value; and
verifying the input data using the metadata.

5. The method of claim 1, wherein the data threshold is based on a predetermined number of sectors of the input data to be included in the compression operation.

6. The method of claim 5, wherein the predetermined number of sectors is based on a compression device configured to perform the compression operation, a size of a pipeline in the compression device, resource availability in the compression device, and latency restrictions in the compression device.

7. The method of claim 5, wherein in response to a grouping of a first sector of the input data and a second sector of the input data satisfy the data threshold, and a grouping of the first sector, the second sector, and a third sector of the input data not satisfying the data threshold:
arranging the first sector and the second sector for the compression operation and not arranging the third sector for the compression operation; and
arranging first metadata associated with the first sector and second metadata associated with the second sector for the compression operation and not arranging third metadata associated with the third sector for the compression operation.

8. The method of claim 1, wherein the metadata is T10-data integrity field (DIF) metadata and is embedded in the input data.

9. The method of claim 1, wherein the metadata is T10-data integrity extension (DIX) metadata, is disposed in a buffer separate from the input data, and is transmitted separately from the input data.

10. The method of claim 1, wherein the preprocessing comprises:
identifying at least a first field and a second field associated with the metadata;
grouping the first field of a first metadata with the first field of a second metadata prior to the compression operation; and
grouping the second field of the first metadata with the second field of the second metadata prior to the compression operation.

11. The method of claim 1, wherein the arranging comprises:
grouping the input data in an amount to satisfy the data threshold; and
grouping the metadata associated with the grouped input data and disposing the grouped metadata adjacent to the grouped input data.

12. The method of claim 1, wherein the compression operation is performed by a data transform accelerator.

13. A system, comprising:
a host device, configured to:
obtain input data to be compressed by a compression operation;
obtain metadata associated with the input data, to be compressed by the compression operation;
determine a data threshold using the input data and the metadata;
preprocess the metadata;
arrange the input data based on the data threshold and arranging the metadata based on the arranged input data; and
transmit the arranged input data and the arranged metadata to a compression device; and
the compression device, configured to perform the compression operation on the arranged input data and the arranged metadata.

14. The system of claim 13, wherein:
in response to the metadata being empty, the host device is further configured to add metadata to the input data; and
the added metadata is determined based on user input and compute operations performed by a compression device performing the compression operation.

15. The system of claim 13, wherein the host device is further configured to:
verify the metadata by comparing the metadata to an expected value; and
verify the input data using the metadata.

16. The system of claim 13, wherein:
the data threshold is based on a predetermined number of sectors of the input data to be included in the compression operation; and
the predetermined number of sectors is based on a compression device configured to perform the compression operation, a size of a pipeline in the compression device, resource availability in the compression device, and latency restrictions in the compression device.

17. The system of claim 13, wherein the metadata is T10-DIF metadata and is embedded in the input data.

18. The system of claim 13, wherein the preprocessing comprises:
identifying at least a first field and a second field associated with the metadata;
grouping the first field of a first metadata with the first field of a second metadata prior to the compression operation; and
grouping the second field of the first metadata with the second field of the second metadata prior to the compression operation.

19. The system of claim 13, wherein the arranging comprises:
grouping the input data in an amount to satisfy the data threshold; and
grouping the metadata associated with the grouped input data and disposing the grouped metadata adjacent to the grouped input data.

20. The system of claim 13, wherein the compression device is a data transform accelerator.
